(19) United States
(12) Patent Application Publication
(10) Pub. No.: US 2008/0029349 A1
(43) Pub. Date: Feb. 7, 2008

(54) Non-personal-contact electric switch apparatus

(76) Inventor: James W. Poppell, Perry, FL (US)

Correspondence Address: S. Michael Bender, P.O. Box 530-399, St. Petersburg, FL, 33747, US

(21) Appl. No.: 11/499,143

(22) Filed: Aug. 7, 2006

(51) Int. Cl. B66B 1/34

(52) U.S. Cl. 187/395

(57) ABSTRACT

A non-personal-contact electric switch apparatus includes an actuator-reception well which includes a minimum internal dimension which is substantially greater than a maximum outer dimension of an actuator. The actuator-reception well includes a pair of opposed light transmissive regions. A light emitter is located adjacent to a first of the light transmissive regions outside the actuator-reception well. The light emitter projects a light beam. A light receiver/light sensitive switch is located adjacent to a second of the light transmissive regions outside the actuator-reception well. The light receiver/light sensitive switch is responsive to the light beam emitted by the light emitter that is broken by the actuator. Since the minimum internal dimension of the actuator-reception well is substantially greater than a maximum outer dimension of an actuator, when the actuator is inserted into the actuator-reception well, the actuator does not physically contact the inside of the actuator-reception well.

### BACKGROUND OF THE INVENTION

1. Field of the Invention

The present invention relates generally to electric switches, and, more particularly, to non-personal-contact electric switches.

2. Description of the Prior Art

Non-personal-contact electric switches are well known in the art. Such non-personal-contact electric switches are often used when activation of an electric circuit is to be attained without employing a manually-actuated switch. It is understood by the present inventor that there are certain environments wherein many different persons activate manually-actuated switches. Among environments in which many different persons activate manually-actuated switches, a well-known environment is an elevator.

It has been conceived by the present inventor that such manually-actuated switches can be sources for the spread of communicable diseases or the spread of harmful substances. An infected or contaminated person can press a particular elevator switch at one point in time, and, at a later point in time, another person may become infected or contaminated by manually contacting the particular elevator switch. Therefore, to prevent the infection or contamination by a person using a switch in a publicly used environment, it would be desirable if a non-personal-contact electric switch were provided in a publicly used environment. Other publicly used environments where manually-actuated switches are used include light switches in public buildings.

There are a number of technologies that are employed in conventional non-personal-contact electric switches. One such technology depends upon proximity to an electric conductor, and changes in capacitance activate the switch. Such capacitance-based non-personal-contact electric switches would not be practical in publicly used environment. This is so because, for example, one person may wear gloves, and another person may not wear gloves. The changes in capacitance between a person wearing a glove and another person not wearing a glove may be difficult to account for in a capacitance-based non-personal-contact electric switch. In this respect, it would be desirable if a non-personal-contact electric switch were provided for a switch used in a publicly used environment which does not depend upon capacitance sensing technology.

A second technology that is used in non-personal-contact electric switches is based upon sensing a break in a light beam. Such a technology does not depend upon whether a person is wearing a glove or not. In this respect, generally, it would be desirable if a non-personal-contact electric switch for a publicly used environment were provided which uses a technology based upon a break in a light beam to actuate a switch.

As stated above, an elevator is an environment in which switches are actuated in a publicly used environment. In this respect, a number of innovations have been developed relating to switches used in elevators, and the following U.S. patents are representative of some of those innovations: U.S. Pat. Nos. 4,042,067 and 4,716,992. More specifically, U.S. Pat. No. 4,042,067 discloses an elevator system which can employ either capacitance based proximity switches or touch contact switches. Problems associated with capacitance based switches and touch contact switches for switches used in a publicly used environment have been discussed above.

U.S. Pat. No. 4,716,992 discloses an operating panel device for an elevator system. In FIG. 3A of U.S. Pat. No. 4,716,992, there is a disclosure of a two-dimensional matrix array of six light emitters and six light receivers to provide switching for eight switching choices. Although this two-dimensional matrix arrangement is efficient in the use of pairs of light emitters and light receivers, multiple problems would arise if only one of the six light emitters or one of the six light receivers would malfunction. Then, either two or four switching choices would be deactivated, depending upon whether a row or column of switching choices in the two-dimensional matrix were malfunctioning. To avoid multiple switch malfunctions if only one light emitter or one light receiver malfunctions, it would be desirable to provide non-personal-contact electric switches in a publicly used environment, such as an elevator, which do not employ a two-dimensional matrix array of light emitters and light receivers to actuate plural switches.

In FIG. 3B of U.S. Pat. No. 4,716,992, there is a disclosure of a one-dimensional matrix of light emitters and light receivers which are adjacent to an indicator panel 11 on which floor numbers are printed. When a person selects a specific floor, the person presses one's finger on the number on the indicator panel 11, thereby breaking the light beam between the respective light emitter and light receiver for that floor number. Thus, even though the switch array employs light emitters and light receivers for floor selection, the switch array still employs an area which is contacted by manual touching when a light beam is broken between a light emitter and a light receiver. In this respect, it would be desirable to provide non-personal-contact electric switches in a publicly used environment, such as an elevator, which do employ light emitters and light receivers to actuate plural switches but do not also employ an area which is contacted by manual touching when a light beam is broken between a light emitter and a light receiver for actuating a switch.

Thus, while the foregoing body of prior art indicates it to be well known to use a non-personal-contact electric switch, the prior art described above does not teach or suggest a non-personal-contact electric switch apparatus which has the following combination of desirable features: (1) provides a non-personal-contact electric switch which is used in a publicly used environment; (2) provides a non-personal-contact electric switch for a switch use in a publicly used environment which does not depend upon capacitance sensing technology; (3) provides a non-personal-contact electric switch for a publicly used environment which uses a technology based upon a break in a light beam to actuate a switch; (4) provides a non-personal-contact electric switch in a publicly used environment, such as an elevator, which is not employed in a two-dimensional matrix array of light emitters and light receivers to actuate plural switches; and (5) employs light emitters and light receivers to actuate plural switches but does not also employ an area which is contacted by manual touching when a light beam is broken between a light emitter and a light receiver for actuating a switch. The foregoing desired characteristics are provided by the unique non-personal-contact electric switch apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a non-personal-contact electric switch apparatus which includes an actuator-reception well which includes a minimum internal dimension which is substantially greater than a maximum outer dimension of an actuator. The actuator-reception well includes a pair of opposed light transmissive regions. A light emitter is located adjacent to a first of the light transmissive regions outside the actuator-reception well. The light emitter projects a light beam. A light receiver/light sensitive switch is located adjacent to a second of the light transmissive regions outside the actuator-reception well. The light receiver/light sensitive switch is responsive to the light beam emitted by the light emitter that is broken by the actuator. Since the minimum internal dimension of the actuator-reception well is substantially greater than a maximum outer dimension of an actuator, when the actuator is inserted into the actuator-reception well, the actuator does not physically contact the inside of the actuator-reception well.

Preferably, the actuator-reception well is cylindrical is shape and has a minimum internal dimension which is a cylindrical diameter. Preferably, the actuator is a finger which has a maximum outer dimension which is the diameter of the finger, so that the cylindrical diameter is substantially greater than the diameter of the finger.

Preferably, the light transmissive regions are open light passage channels in the actuator-reception well. The light emitter can be a light emitting diode (LED).

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved non-personal-contact electric switch apparatus which has all of the advantages of the prior art and none of the disadvantages.

It is another object of the present invention to provide a new and improved non-personal-contact electric switch apparatus which may be easily and efficiently manufactured and marketed.

It is a further object of the present invention to provide a new and improved non-personal-contact electric switch apparatus which is of durable and reliable construction.

An even further object of the present invention is to provide a new and improved non-personal-contact electric switch apparatus which is susceptible of a low cost of manufacture with regard to both materials and labor, and which accordingly is then susceptible of low prices of sale to the consuming public, thereby making such non-personal-contact electric switch apparatus available to the buying public.

Still yet a further object of the present invention is to provide a new and improved non-personal-contact electric switch apparatus which provides a non-personal-contact electric switch which is used in a publicly used environment.

Still another object of the present invention is to provide a new and improved non-personal-contact electric switch apparatus that provides a non-personal-contact electric switch for use in a publicly used environment which does not depend upon capacitance sensing technology.

Yet another object of the present invention is to provide a new and improved non-personal-contact electric switch apparatus which provides a non-personal-contact electric switch for a publicly used environment which uses a technology based upon a break in a light beam to actuate a switch.

Even another object of the present invention is to provide a new and improved non-personal-contact electric switch apparatus that provides a non-personal-contact electric switch in a publicly used environment, such as an elevator, which is not employed in a two-dimensional matrix array of light emitters and light receivers to actuate plural switches.

Still a further object of the present invention is to provide a new and improved non-personal-contact electric switch apparatus which employs light emitters and light receivers to actuate plural switches but does not also employ an area which is contacted by manual touching when a light beam is broken between a light emitter and a light receiver for actuating a switch.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a preferred embodiment of the non-personal-contact electric switch apparatus of the invention in an elevator switch panel which employs conventional touch contact buttons and non-personal-contact electric switches of the invention.

FIG. 2 is an enlarged view of one non-personal-contact electric switch apparatuses of the invention, contained in circled area 2 of FIG. 1. of the embodiment of the non-personal-contact electric switch apparatus shown in FIG. 1 taken along line 2-2 of FIG. 1.

FIG. 3 is a top cross-sectional view of the embodiment of the non-personal-contact electric switch apparatus of FIG. 2 taken along line 3-3 thereof, wherein a light beam is continuous for a non-actuated switch.

FIG. 4 is a view of the embodiment of the invention shown in FIG. 3, wherein a light beam is broken by a person's finger for an actuated switch.

FIG. 5 is a perspective view of the embodiment of the invention shown in FIG. 4, wherein a light beam is broken by a person's finger for an actuated switch.

FIG. 6 is a block diagram showing the relationship between a light emitter, a light sensitive switch, and a relay controlled by the light sensitive switch.

### DESCRIPTION OF THE PREFERRED EMBODIMENT

With reference to the drawings, a new and improved non-personal-contact electric switch apparatus embodying the principles and concepts of the present invention will be described.

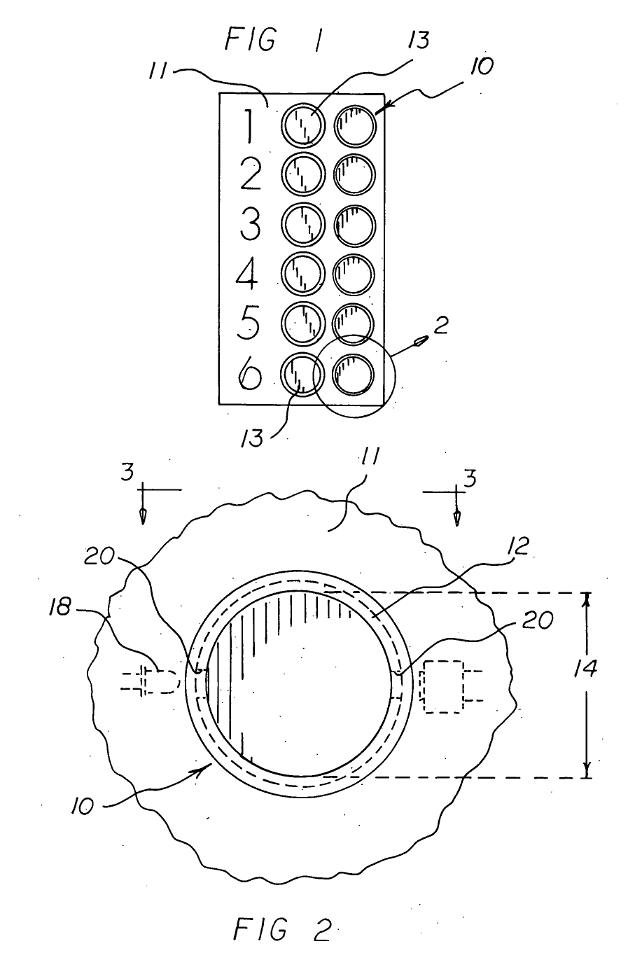

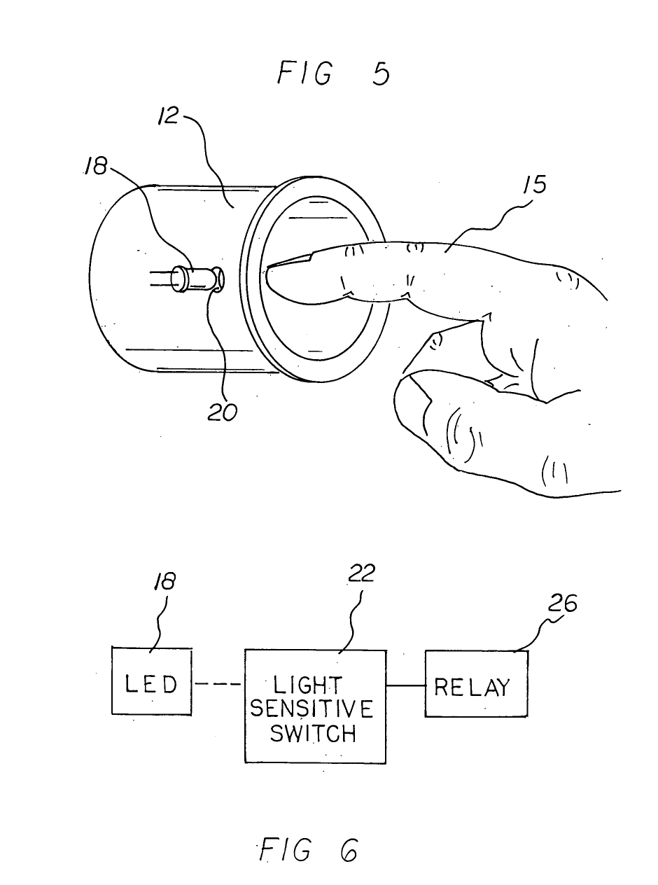

Turning to FIGS. 1-6, there is shown a preferred embodiment of the non-personal-contact electric switch apparatus of the invention generally designated by reference numeral 10. In each of the figures, reference numerals are shown that correspond to like reference numerals that designate like elements shown in other figures.

In the preferred embodiment, non-personal-contact electric switch apparatus 10 includes an actuator-reception well 12 which includes a minimum internal dimension 14 which is substantially greater than a maximum outer dimension 16 of an actuator. The actuator-reception well 12 includes a pair of opposed light transmissive regions. A light emitter 18 is located adjacent to a first of the light transmissive regions outside the actuator-reception well 12. The light emitter 18 projects a light beam 24. A light receiver/light sensitive switch 22 is located adjacent to a second of the light transmissive regions outside the actuator-reception well 12. The light receiver/light sensitive switch 22 is responsive to the light beam 24 emitted by the light emitter 18 that is broken by the actuator. The light receiver/light sensitive switch 22 can control another electrical device, such as a relay 26 for controlling a motor, such as an elevator motor.

Since the minimum internal dimension 14 of the actuator-reception well 12 is substantially greater than a maximum outer dimension 16 of an actuator, when the actuator is inserted into the actuator-reception well 12, the actuator does not physically contact the inside of the actuator-reception well 12.

Preferably, the actuator-reception well 12 is cylindrical is shape and has a minimum internal dimension 14 which is a cylindrical diameter. Preferably, the actuator is a finger 15 which has a maximum outer dimension 16 which is the diameter of the finger, so that the cylindrical diameter is substantially greater than the diameter of the finger. The actuator can also be an opaque object such as a pointer rod (not shown) that is carried by a person and is inserted in an actuator-reception well 12 for a switch apparatus according to the invention.

Preferably, the light transmissive regions are open light passage channels 20 in the actuator-reception well 12. The light emitter 18 can be a light emitting diode (LED).

As shown in FIG. 1, an elevator switch panel 11 can includes an array of conventional touch contact buttons 13 in conjunction with an array of non-personal-contact electric switch apparatuses 10 of the invention.

In operation of the array of non-personal-contact electric switch apparatuses 10 shown in FIG. 1, all of the unselected non-personal-contact electric switch apparatuses 10 of the invention includes an unbroken light beam 24, as shown in FIG. 3, which is emitted from the light emitter 18, passes through an adjacent open light passage channel 20, passes across the inside of the actuator-reception well 12, passes through the opposite open light passage channel 20, and is received by the light receiver/light sensitive switch 22.

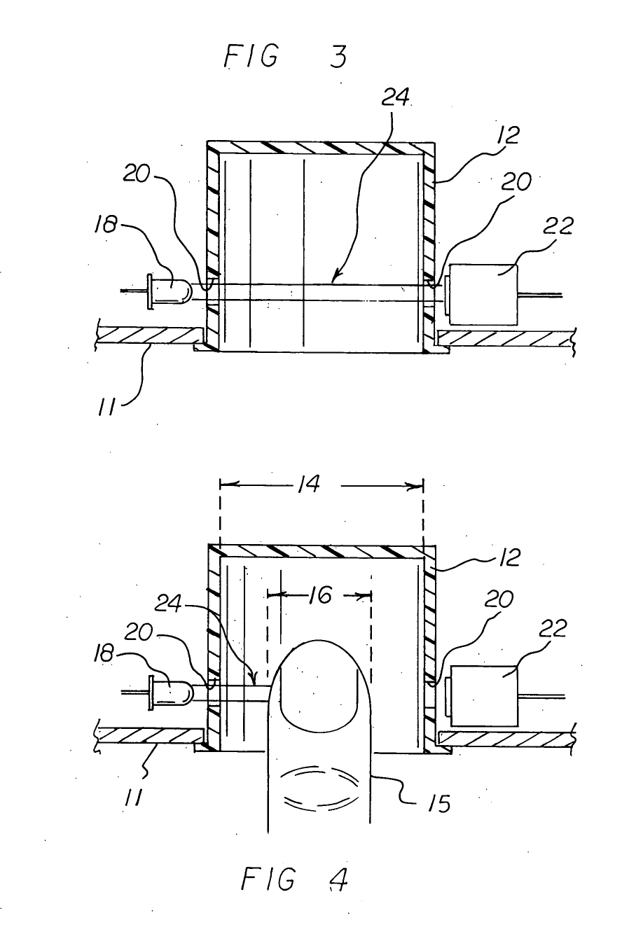

As shown in FIG. 4, when a person selects a specific floor for the elevator, the person inserts one's finger 15 into a selected non-personal-contact electric switch apparatus 10 associated with the selected floor. More specifically, the person's finger 15 is inserted in the actuator-reception well 12 so that the light beam 24 from the light emitter 18 is broken or blocked by the finger 15 so that the light beam 24 does not reach the light receiver/light sensitive switch 22. When the light receiver/light sensitive switch 22 does not receive the light beam 24, the light receiver/light sensitive switch 22 changes its status and can control other electrical circuit devices, such as relay 26, (shown in FIG. 6) for controlling the elevator.

The components of the non-personal-contact electric switch apparatus of the invention can be made from inexpensive and durable metal and plastic materials and electrical components.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved non-personal-contact electric switch apparatus that is low in cost, relatively simple in design and operation, and which may advantageously be used in a publicly used environment. With the invention, a non-personal-contact electric switch apparatus provides a non-personal-contact electric switch for use in a publicly used environment which does not depend upon capacitance sensing technology. With the invention, a non-personal-contact electric switch apparatus provides a non-personal-contact electric switch for a publicly used environment which uses a technology based upon a break in a light beam to actuate a switch. With the invention, a non-personal-contact electric switch apparatus provides a non-personal-contact electric switch in a publicly used environment, such as an elevator, which is not employed in a two-dimensional matrix array of light emitters and light receivers to actuate plural switches. With the invention, a non-personal-contact electric switch apparatus is provided which employs light emitters and light receivers to actuate plural switches but does not also employ an area which is contacted by manual touching when a light beam is broken between a light emitter and a light receiver for actuating a switch.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A non-personal-contact electric switch apparatus, comprising:
an actuator-reception well which includes a minimum internal dimension which is substantially greater than a maximum outer dimension of an actuator, wherein said actuator-reception well includes a pair of opposed light transmissive regions,
a light emitter located adjacent to a first of said light transmissive regions outside said actuator-reception well, wherein said light emitter projects a light beam, and
a light receiver/light sensitive switch located adjacent to a second of said light transmissive regions outside said actuator-reception well, wherein said light receiver/light sensitive switch is responsive to said light beam emitted by said light emitter that is broken by the actuator.

2. The apparatus of claim 1 wherein:
said actuator-reception well is cylindrical and has a minimum internal dimension which is a cylindrical diameter, and
the actuator is a finger which has a maximum outer dimension which is the diameter of the finger, so that said cylindrical diameter is substantially greater than the diameter of the finger.

3. The apparatus of claim 1 wherein said light transmissive regions are open light passage channels in said actuator-reception well.

4. The apparatus of claim 1 wherein said light emitter can be a light emitting diode (LED).

5. The apparatus of claim 2 wherein said actuator reception well is contained in an elevator control panel and said light receiver/light sensitive switch is connected to the control circuit operated by said elevator control panel.

6. The apparatus of claim 5 wherein said elevator panel further includes at least one touchable switch connected to said control circuit and said light receiver/light sensitive switch is adapted to be optionally actuated in lieu of said at least one touchable switch.
